(19) United States
(12) Patent Application Publication
(10) Pub. No.: US 2006/0233974 A1
(43) Pub. Date: Oct. 19, 2006

(54) ARTICLE HAVING AN ORNAMENTAL SURFACE AND METHOD OF MANUFACTURING THE SAME

(76) Inventor: Hsin-Le Chen, Danshuei Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/907,719

(22) Filed: Apr. 13, 2005

(51) Int. Cl. D04D 7/10; B32B 27/00

(52) U.S. Cl. 428/5; 428/319.3

(57) ABSTRACT

A method for manufacturing articles that have an ornamental surface which has a plurality of debris bonded thereon, includes the steps of: fabricating molds of an article; bonding a plurality of debris to the surface of the molds through an adhesive; adding a desired amount of curing agent into a resin and mixing the materials evenly through a mixing device; injecting the resin contained the curing agent into the molds; removing the formed article after cured from the molds that contains the debris; polishing the surface of the article through a polishing machine until smooth; and coating the surface of the article with a layer of wax. The method can produce delicate articles with a greater versatility, and provide a higher applicability in the industry.

### FIELD OF THE INVENTION

The present invention relates to a method for manufacturing molded products and particularly to a method that provides a design and machining on the surface of a molded product before the product is formed so that the molded product has an ornamental surface after being released from the mold.

### BACKGROUND OF THE INVENTION

Articles produced through the conventional molds generally are formed in a simple and plain fashion. To make alterations on the product surface, the generally approach is to fix some ornamental articles on the surface of the semi-finished product after it is released from the mold. However, the present trend of producing products with molds is to form the product integrally in a delicate fashion to reduce the downstream machining. Hence the conventional techniques are no longer competitive. And the conventional manufacturing method with molds has encountered technical bottlenecks that remain to be overcome.

### SUMMARY OF THE INVENTION

Therefore the primary object of the invention is to provide a surface processing method for molded products that forms an ornamental surface on an article so that the article may be designed in a delicate fashion and become more versatile.

Another object of the invention is to provide a manufacturing method that has a higher practicality and applicability, and can produce articles with a smooth and ornamental surface.

Refer to FIG. 1 for the process flow chart of the manufacturing method of the invention. Step 10 is to fabricate molds of an article. Step 12 is to bond a plurality of debris on the surface of the molds through adhesives. Step 14 is to add a desired amount of curing agent in a resin and mix the materials through a mixing device. Step 16 is to inject the resin that contains the curing agent into the molds, and remove the formed article that contains the debris from the molds after cured. Step 18 is to polish the surface of the article through a polishing machine to form a smooth surface, and coat a layer of polishing wax on the surface to become a finished product with an ornamental surface.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a process flow chart of the manufacturing method of the invention:

FIGS. 2A and 2B are schematic views of an embodiment of the manufacturing method of the invention.

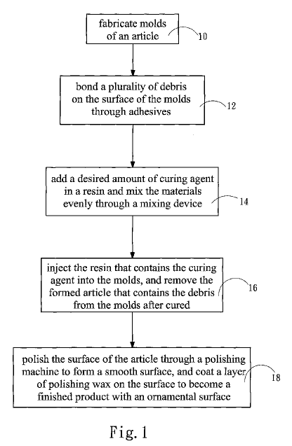

### DESCRIPTION OF THE PREFERRED EMBODIMENTS

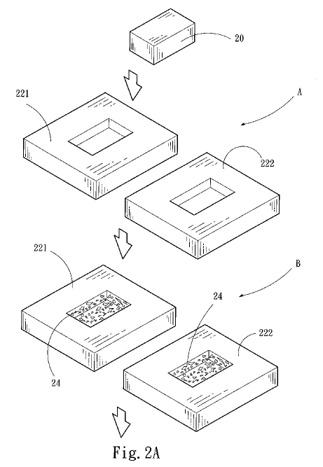

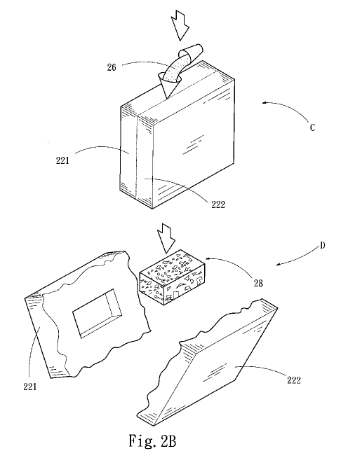

Refer to FIGS. 2A and 2B for an embodiment of the invention. First, Step A, fabricate a mold for a molded article 20. The mold is made from silicon rubber, and includes a lower portion 221 and a upper portion 222. Step B, bond a plurality of pearl and shell debris 24 on the surface of the molds 221 and 222 through adhesives; add a desired amount of curing agent in a saturated or unsaturated resin, and mix the materials evenly through a mixing device. Step C and D are to inject the resin 26 that contains the curing agent into the molds 221 and 222, and remove a formed article 28 that contains the pearl and shell debris 24 from the molds after cured. Finally, polish the surface of the formed article 28 through a polishing machine to form a smooth surface, and coat a layer of polishing wax on the surface to become a finished product with an ornamental surface. The ornamental surface on the formed article 20 consists of the pearl and shell debris 24 bonded thereon. It is to be noted that the pearl and shell debris used in the embodiment is not the limitation of the invention. Other types and shapes of materials may also be used as the ornamental article.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for manufacturing articles that have an ornamental surface which consists of a plurality of debris bonding thereon, comprising the steps of:
fabricating molds of an article;
bonding the debris on the surface of the molds through an adhesive;
adding a desired amount of a curing agent into a selected resin and mixing evenly the curing agent and the resin through a mixing device;
injecting the resin that contains the curing agent into the molds and curing the resin, and removing a formed article that contains the debris from the molds; and
polishing the surface of the article through a polishing machine to become smooth and coating a layer of wax on the article surface that contains the ornamental debris.

2. The method of claim 1, wherein the molds are made from silicon rubber.

3. The method of claim 1, wherein the debris is made from pearls and shells.

4. An article having an ornamental surface which has a plurality of debris bonded on the surface through a manufacturing process, the manufacturing process comprising the steps of:
(a) fabricating molds of an article;
bonding the debris on the surface of the molds through an adhesive;
adding a desired amount of a curing agent into a selected resin and mixing evenly the curing agent and the resin through a mixing device;
injecting the resin that contains the curing agent into the molds and curing the resin, and removing a formed article that contains the debris from the molds; and
polishing the surface of the article through a polishing machine to become smooth and coating a layer of wax on the article surface that contains the ornamental debris.

5. The article of claim 4, wherein the molds are made from silicon rubber.

6. The article of claim 4, wherein the debris is made from pearls and shells.
